(19) United States
(12) Patent Application Publication
(10) Pub. No.: US 2025/0175444 A1
(43) Pub. Date: May 29, 2025

(54) SUBPROGRAM SHARING METHOD AND APPARATUS, AND ELECTRONIC DEVICE AND STORAGE MEDIUM

(71) Applicant: Tencent Technology (Shenzhen) Company Limited, Shenzhen (CN)

(72) Inventor: Kangzhuang WU, Shenzhen (CN)

(73) Assignee: Tencent Technology (Shenzhen) Company Limited, Shenzhen (CN)

(21) Appl. No.: 19/038,890

(22) Filed: Jan. 28, 2025

Related U.S. Application Data
(63) Continuation of application No. PCT/CN2024/072448, filed on Jan. 16, 2024.

(30) Foreign Application Priority Data
Jan. 31, 2023 (CN) 202310129492.3

(51) Int. Cl. H04L 51/046; B60K 35/28; H04W 4/40; H04W 12/069

(52) U.S. Cl. CPC H04L 51/046; B60K 35/28; H04W 4/40; H04W 12/069; B60K 2360/164

(57) ABSTRACT

A subprogram sharing method, executed by a terminal device, includes displaying a subprogram sharing page of a subprogram, the subprogram sharing page including at least one sharing mode selection control, wherein the at least one sharing mode selection control corresponds to at least one communication mode; acquiring target intelligent vehicle information of a target vehicle and subprogram association information of the subprogram based on a first triggering operation for a first control among sharing mode selection controls; and transmitting a subprogram sharing request to the target vehicle based on a communication mode corresponding to the first control, the subprogram sharing request carrying the subprogram association information, to cause the target vehicle to display, via a first display of the target vehicle, a target subprogram page corresponding to the subprogram based on the subprogram association information.

### CROSS-REFERENCE TO RELATED APPLICATIONS

This application is a continuation application of International Application No. PCT/CN2024/072448 filed on Jan. 16, 2024, which claims the priority to Chinese Patent Application No. 202310129492.3, filed with the China National Intellectual Property Administration on Jan. 31, 2023, the disclosures of each being incorporated by reference herein in their entireties.

### FIELD

The present disclosure relates to the field of intelligent vehicles, and in particular, to a subprogram sharing method and apparatus, an electronic device, and a storage medium.

### BACKGROUND

With the rapid development of current economy and science, intelligent vehicles are increasingly common in people's daily life. Drivers of intelligent vehicles hardly operate the intelligent vehicles complexly and precisely while driving the vehicles. Non-driving personnel may use an electronic device for data sharing, so that the drivers also can acquire relevant information.

In some methods of sharing data to the intelligent vehicles, the non-driving personnel transmits data through a Bluetooth connection between the electronic device and the intelligent vehicles.

### SUMMARY

Provided are a subprogram sharing method and apparatus, an electronic device, and a storage medium.

According to an aspect of the disclosure, a subprogram sharing method, executed by a terminal device, includes displaying a subprogram sharing page of a subprogram, the subprogram sharing page including at least one sharing mode selection control, wherein the at least one sharing mode selection control corresponds to at least one communication mode; acquiring target intelligent vehicle information of a target vehicle and subprogram association information of the subprogram based on a first triggering operation for a first control among a plurality of sharing mode selection controls; and transmitting a subprogram sharing request to the target vehicle based on a communication mode corresponding to the first control, the subprogram sharing request carrying the subprogram association information, to cause the target vehicle to display, via a first display of the target vehicle, a target subprogram page corresponding to the subprogram based on the subprogram association information.

According to an aspect of the disclosure, a terminal device includes at least one memory configured to store computer program code; and at least one processor configured to read the program code and operate as instructed by the program code, the program code including first page display code configured to cause at least one of the at least one processor to display a subprogram sharing page of a subprogram, the subprogram sharing page including at least one sharing mode selection control, and wherein the at least one sharing mode selection control corresponds to at least one communication mode; information acquisition code configured to cause at least one of the at least one processor to acquire target intelligent vehicle information of a target vehicle and subprogram association information of the subprogram based on a first triggering operation for a first control among a plurality of sharing mode selection controls; and information transmitting code configured to cause at least one of the at least one processor to transmit a subprogram sharing request to the target vehicle end based on a communication mode corresponding to the first control, the subprogram sharing request carrying the subprogram association information, to cause the target vehicle to display, via a first display of the target vehicle, a target subprogram page corresponding to the subprogram based on the subprogram association information.

According to an aspect of the disclosure, a non-transitory computer-readable storage medium, storing computer code which, when executed by at least one processor, causes the at least one processor to at least display a subprogram sharing page of a subprogram, the subprogram sharing page including at least one sharing mode selection control, and wherein the at least one sharing mode selection control corresponds to at least one communication mode; acquire target intelligent vehicle information of a target vehicle and subprogram association information of the subprogram based on a first triggering operation for a first control among a plurality of sharing mode selection controls; and transmit a subprogram sharing request to the target vehicle end based on a communication mode corresponding to the first control, the subprogram sharing request carrying the subprogram association information, to cause the target vehicle to display, via a first display of the target vehicle, a target subprogram page corresponding to the subprogram based on the subprogram association information.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic scenario diagram of a subprogram sharing method provided in some embodiments.

FIG. 2 is a schematic flowchart of a subprogram sharing method provided in some embodiments.

FIG. 3 is a schematic diagram of a subprogram sharing page provided in some embodiments.

FIG. 4 is another schematic diagram of a subprogram sharing page provided in some embodiments.

FIG. 5 is a schematic diagram of a technology implementation of establishing a Bluetooth communication connection provided in some embodiments.

FIG. 6 is a schematic flowchart of another subprogram sharing method provided in some embodiments.

FIG. 7 is a schematic diagram of a technology implementation of a subprogram sharing process provided in some embodiments.

FIG. 8 is a schematic diagram of another technology implementation of a subprogram sharing process provided in some embodiments.

FIG. 9 is another schematic flowchart of a subprogram sharing method provided in some embodiments.

FIG. 10 is a schematic structural diagram of a subprogram sharing apparatus provided in some embodiments.

FIG. 11 is a schematic structural diagram of another subprogram sharing apparatus provided in some embodiments.

FIG. 12 is another schematic structural diagram of a subprogram sharing apparatus provided in some embodiments.

FIG. 13 is a schematic structural diagram of an electronic device provided in some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Some embodiments provide a subprogram sharing method and apparatus, an electronic device, and a computer-readable storage medium. The subprogram herein may also be referred to as a mini program or a small scene (it may be referred to as a small scene in a vehicle-mounted device). Some embodiments provide a subprogram sharing method for a subprogram sharing apparatus, and the subprogram sharing apparatus may be integrated in the electronic device.

The electronic device may be a device such as a terminal and includes, but is not limited to, a mobile terminal and a fixed terminal, where the mobile terminal includes, but is not limited to, a smart phone, a smart watch, a tablet personal computer, a notebook computer, an intelligent vehicle-mounted device, an intelligent vehicle, and the like. The fixed terminal includes, but is not limited to, a desktop computer, a smart television, and the like.

The electronic device may also be a device such as a server. The server may be an independent physical server, or a server cluster or distributed system including a plurality of physical servers, or may be a cloud server for cloud computing services such as a cloud service, a cloud database, cloud computing, a cloud function, cloud storage, a network service, cloud communication, a middleware service, a domain name service, a security service, a content delivery network (CDN), big data, and an artificial intelligence platform, but is not limited thereto.

The subprogram sharing method in some embodiments may be realized by the server or jointly realized by the terminal and the server.

The method is described below taking joint realization of the subprogram sharing method by a sharing initiating terminal, an intelligent vehicle, and a cloud server as an example.

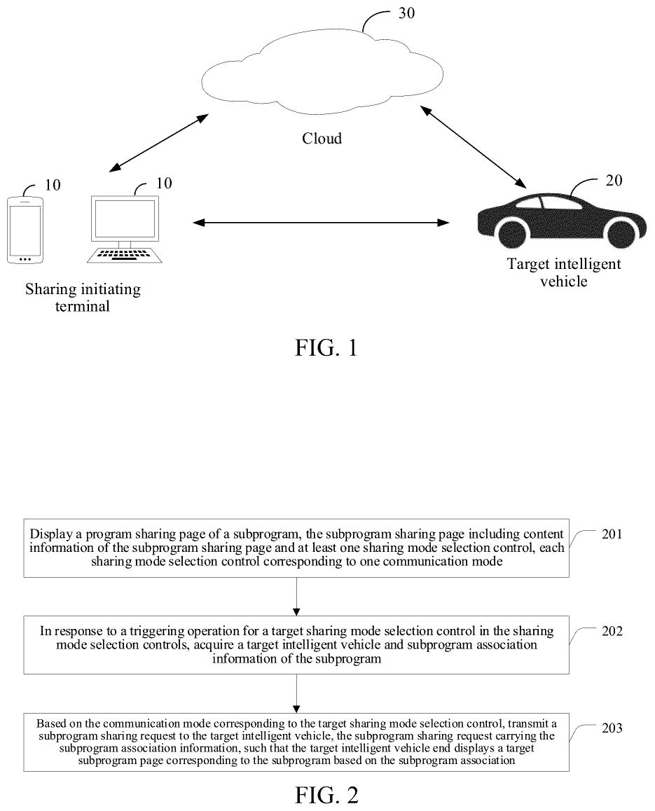

As shown in FIG. 1, a subprogram sharing system provided in some embodiments includes the sharing initiating terminal (i.e., the terminal device) 10, the intelligent vehicle 20, and the cloud server 30, and the like. The sharing initiating terminal 10, the intelligent vehicle 20, and the cloud server 30 are connected via a network, for example, connected via a wired or wireless network.

The sharing initiating terminal 10 may display a subprogram sharing page of a subprogram, the subprogram sharing page including content information of the subprogram and at least one sharing mode selection control, and each sharing mode selection control corresponding to one communication mode, acquire subprogram association information of the subprogram in response to a target vehicle sharing operation for a target sharing mode selection control in sharing mode selection controls, and transmit a subprogram sharing request to the cloud server 30 corresponding to a target intelligent vehicle based on a communication mode corresponding to the target sharing mode selection control, the target intelligent vehicle corresponding to the target vehicle sharing operation and the subprogram sharing request carrying the subprogram association information of a subprogram requested by the sharing imitating end 10 to share.

The cloud server 30 may transmit the subprogram sharing request to the intelligent vehicle 20.

The intelligent vehicle 20 may be configured to receive the subprogram sharing request transmitted by the cloud server 30, the subprogram sharing request including the subprogram association information of the subprogram requested by the sharing initiating terminal to share, display an sharing acceptance confirming page based on the subprogram association information, and display, in response to an sharing acceptance operation of a user, a target subprogram page corresponding to the subprogram according to the subprogram association information.

In some embodiments, the sharing initiating terminal 10 may also directly communicate with the intelligent vehicle 20.

The sharing initiating terminal 10 may display the subprogram sharing page of the subprogram, the subprogram sharing page including content information of the subprogram and at least one sharing mode selection control, and each sharing mode selection control corresponding to one communication mode, acquire the target intelligent vehicle and the subprogram association information of the subprogram in response to a triggering operation for the target sharing mode selection control in the sharing mode selection controls, and transmit the subprogram sharing request to the target intelligent vehicle based on the communication mode corresponding to the target sharing mode selection control, the subprogram sharing request carrying the subprogram association information of the subprogram requested by the sharing imitating end 10 to share.

The intelligent vehicle 20 may be configured to receive the subprogram sharing request transmitted by the sharing initiating terminal 10, the subprogram sharing request carrying the subprogram association information of the subprogram requested by the sharing initiating terminal 10 to share, display the sharing acceptance confirming page based on the subprogram association information, and display, in response to the sharing acceptance operation of the user, the target subprogram page corresponding to the subprogram according to the subprogram association information.

Detailed descriptions are separately provided below. A description order of the following embodiments is not used as a limitation on a priority order.

Some embodiments will be described from an angle of a subprogram sharing apparatus, and the subprogram sharing apparatus may be integrated in the terminal.

As shown in FIG. 2, the subprogram sharing method in some embodiments is executed by the sharing initiating terminal (i.e., the terminal device), where a flow may be as follows:

201: Display a subprogram sharing page of a subprogram, the subprogram sharing page including content information of the subprogram and at least one sharing mode selection control, and each sharing mode selection control corresponding to one communication mode.

The subprogram is a program running dependent on a host program. In some embodiments, the subprogram may be a program dependent on any host program.

In a computer environment, a software environment where software (for example, the mini program in some embodiments) lives on is referred to as a host environment (the host program). The host environment (the host program) may be an operating system, a server program, an application program, and the like.

In some embodiments, the types of the host program and the subprogram are not limited. For example, the host program may be an instant messaging client program, a music play program, and the like.

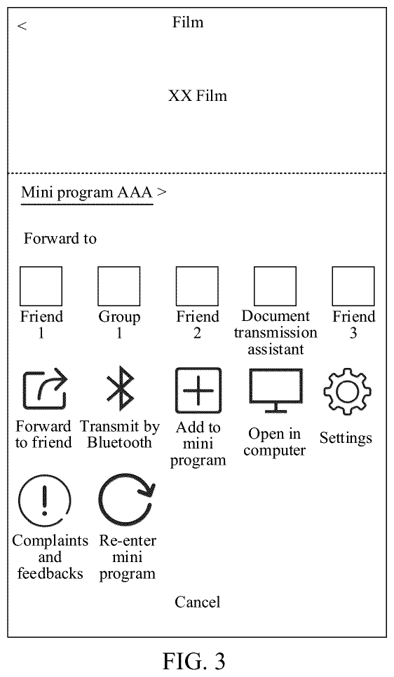

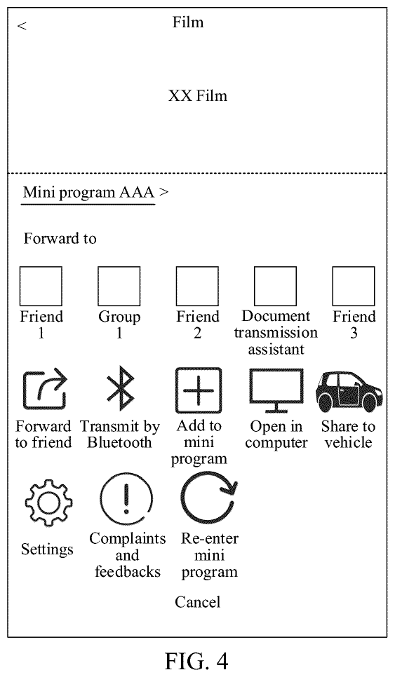

The subprogram sharing page is a page through which the user of the subprogram may choose to share the subprogram with themselves or other users. For example, the subprogram sharing page may be shown in FIG. 3 or FIG. 4.

In some embodiments, the sharing mode selection control may be used for the user to select a communication model when sharing the subprogram. For example, the sharing mode selection control may be a control named “transmit via Bluetooth” in FIG. 3 or FIG. 4, or, the sharing mode selection control may be a control named “share to the vehicle” in FIG. 4.

The communication modes corresponding to different sharing mode selection controls may be different. For example, the control named “transmit via Bluetooth” in FIG. 3 or FIG. 4 corresponds to a Bluetooth communication mode, and the control named “share to the vehicle” in FIG. 4 may correspond to a remote wireless communication mode, and the like.

The subprogram sharing page may further have sharing mode selection controls corresponding to other communication modes. For example, the subprogram sharing page may further include a sharing mode selection control corresponding to a wired communication mode, and the like, which is not limited.

202: Acquire a target intelligent vehicle and subprogram association information of the subprogram in response to a triggering operation for a target sharing mode selection control in sharing mode selection controls.

The target sharing mode selection control is a sharing mode selection control triggered by the user of the sharing initiating terminal in a vehicle subprogram sharing process.

For example, the user may trigger the control named “transmit via Bluetooth” in FIG. 3 or FIG. 4, and the control named “share to the vehicle” is the target sharing mode selection control.

The subprogram association information may include, but not limited to, information such as a subprogram identifier (Appid), page information, page parameters params corresponding to the subprogram. For example, the subprogram identifier may a corresponding program ID of the subprogram in the host program, and the like.

The target sharing mode selection control may directly correspond to one intelligent vehicle. For example, the control named “transmit via Bluetooth” in FIG. 3 may correspond to one intelligent vehicle. Then, in response to the triggering operation for the target sharing mode selection control in the sharing mode selection controls, the target intelligent vehicle (i.e., the intelligent vehicle corresponding to the target sharing mode selection control) may be directly acquired.

Or, the target sharing mode selection control may correspond to one sharing vehicle selection page, the sharing vehicle selection page including a vehicle selection control corresponding to at least one intelligent vehicle. Then, the acquiring a target intelligent vehicle in response to a triggering operation for a target sharing mode selection control in sharing mode selection controls may include:
displaying a sharing vehicle selection page in response to the triggering operation for the target sharing mode selection control in the sharing mode selection controls, the sharing vehicle selection page including the vehicle selection control corresponding to at least one intelligent vehicle; and
determining the target intelligent vehicle in response to the triggering operation for a target sharing mode selection control in the vehicle selection controls, the target intelligent vehicle corresponding to the target sharing mode selection control.

When the sharing initiating terminal may communicate with a plurality of intelligent vehicles, the target intelligent vehicle may be determined from the intelligent vehicles through an operation of the user for the vehicle selection control.

For example, the sharing initiating terminal may communicate with an intelligent vehicle 1 in a Bluetooth communication mode and communicate with an intelligent vehicle 2 and an intelligent vehicle 3 in a remote wireless communication mode. The sharing vehicle selection page may include vehicle selection controls respectively corresponding to the intelligent vehicle 1, the intelligent vehicle 2, and the intelligent vehicle 3. If the user triggers a vehicle selection control corresponding to the intelligent vehicle 2, the vehicle selection control corresponding to the intelligent vehicle 2 is the target vehicle selection control, and the intelligent vehicle 2 is the target intelligent vehicle.

The triggering operation may include operations such as clicking/tapping, double-clicking/tapping, long-pressing, and sliding. In some examples, the control may also be triggered through a preset shortcut operation. For example, it may be set that a terminal user presses a volume reducing button, which is considered one triggering operation for the target sharing mode selection control, and the like. The shortcut operation is not limited herein.

203: Transmit a subprogram sharing request to the target intelligent vehicle based on a communication mode corresponding to the target sharing mode selection control, the subprogram sharing request carrying the subprogram association information of a subprogram requested by a sharing initiating terminal to share, such that the target intelligent vehicle displays a target subprogram page corresponding to the subprogram based on the subprogram association information.

In some embodiments, the target sharing mode selection control may correspond to the Bluetooth communication mode, and in operation 203, the transmitting a subprogram sharing request to the target intelligent vehicle based on a communication mode corresponding to the target sharing mode selection control includes:
generating a Bluetooth sharing event based on the Bluetooth communication mode and the subprogram association information; and
transmitting the Bluetooth sharing event to the target intelligent vehicle through a Bluetooth communication connection between the target intelligent vehicle and the sharing initiating terminal.

The Bluetooth sharing event is a subprogram sharing event generated by the sharing initiating terminal that shares the subprogram for the target intelligent vehicle in the Bluetooth communication mode.

Prior to the transmitting the Bluetooth sharing event to the target intelligent vehicle through a Bluetooth communication connection, the Bluetooth communication connection may be established between the target intelligent vehicle and the sharing initiating terminal.

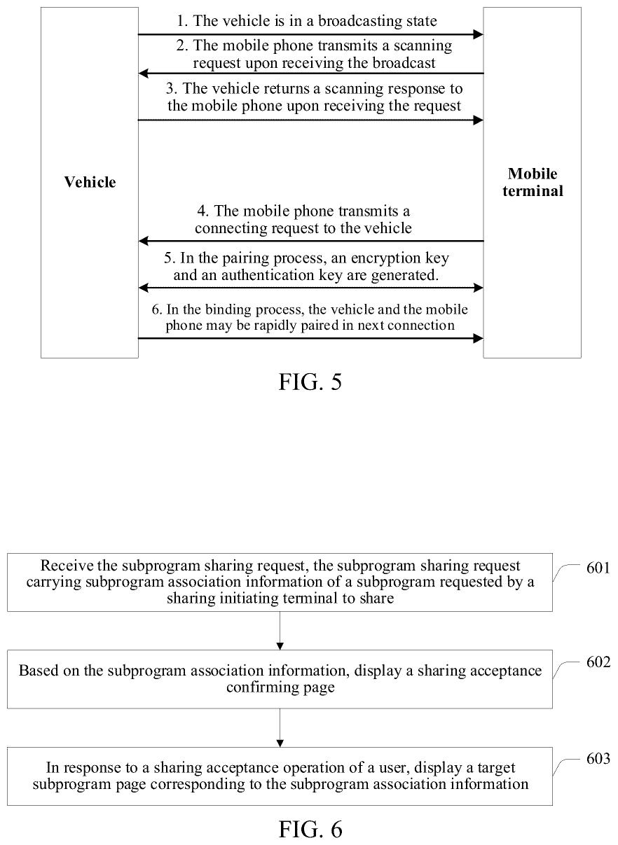

As shown in FIG. 5, device discovery is for the target intelligent vehicle and the sharing initiating terminal (i.e., operations 1, 2, and 3), and then, the target intelligent vehicle and the sharing initiating terminal may perform a device connection through operations 4, 5, and 6, i.e., the Bluetooth communication connection is established.

After the Bluetooth communication connection is established, if the sharing initiating terminal actively calls a sharing interface of the target intelligent vehicle, the sharing initiating terminal may transmit the subprogram association information (for example, information such as Appid, page information, and page parameters params) to the target intelligent vehicle (vehicle) through the Bluetooth communication connection.

In some embodiments, the target sharing mode selection control may correspond to a remote wireless communication mode, and in operation 203, the transmitting a subprogram sharing request to the target intelligent vehicle based on a communication mode corresponding to the target sharing mode selection control includes:
generating a remote sharing event based on the remote wireless communication mode and the subprogram association information;
determining a cloud corresponding to the target intelligent vehicle; and
transmitting the remote sharing event to the cloud through a remote communication connection between the cloud and the sharing initiating terminal, such that the cloud transmits the remote sharing event to the target intelligent vehicle.

The remote sharing event is a subprogram sharing event generated by the sharing initiating terminal that shares the subprogram for the target intelligent vehicle in a remote wireless communication mode. When long-distance subprogram sharing is to be performed, a Bluetooth technology can no longer be used, and the subprogram may be shared by way of the remote wireless communication, for example, wireless network communication.

In a process of wireless network communication, participating nodes in the whole network include the target intelligent vehicle, the cloud server, and the sharing initiating terminal, and the three are independent individuals in the system.

If the sharing initiating terminal has a subprogram sharing demand, i.e., opens a certain subprogram (mini program), the user may click/tap a “more” button at a top right corner of the subprogram to pop more options, select a button of “share to vehicle”, and calls an interface of the cloud to directly transmit the subprogram association information such as Appid, page information, and page parameters params to the cloud through the remote communication connection. The cloud may directly forward the subprogram association information to the target intelligent vehicle, and the target intelligent vehicle analyzes the subprogram association information to obtain all parameters capable of opening the subprogram.

Or, after analyzing the subprogram association information to obtain all parameters capable of opening the subprogram, the cloud may transmit these parameters to the target intelligent vehicle.

In some examples, in order to guarantee the safety of the subprogram sharing process, reliable and safe trust relationship authentication may be established among the target intelligent vehicle, the cloud, and the sharing initiating terminal. The transmitting the remote sharing event to the cloud through a remote communication connection between the cloud and the sharing initiating terminal may include:
transmitting first identity authentication information of the sharing initiating terminal to the cloud through the remote communication connection between the cloud and the sharing initiating terminal, such that the cloud performs identity verification on the sharing initiating terminal based on the first identity authentication information;
receiving an identity verification result of the sharing initiating terminal returned by the cloud; and
transmitting the remote sharing event to the cloud in response to the identity verification result being verification passed.

In an actual application, devices of the target intelligent vehicle, the cloud server, and the sharing initiating terminal and individuals issue corresponding digital certificates as evidence of identity authentication to verify digital signatures of counterparts. The authentication mode may not only identify the individual identity, but also flexibly control a range of application and the service life.

The first identity authentication information may be a digital certificate of the sharing initiating terminal. The identity verification result may be information indicating that the first identity authentication information is inerrant, i.e., verification passed, and may also be information indicating that the first identity authentication information is wrong, i.e., verification failed. When the identity verification result is verification passed, the remote sharing event is transmitted to the cloud; and when the identity verification result is verification failed, it is not allowed to transmit the remote sharing event to the cloud.

In some embodiments, during identity authentication, verification may be based on user information of the host program. For example, the host program may be an instant messaging client, then users registering an instant messaging program can use the subprogram sharing method in some embodiments.

In some embodiments, transmitting the subprogram sharing request may be realized by calling the interface, and in operation 203, the transmitting a subprogram sharing request to the target intelligent vehicle based on a communication mode corresponding to the target sharing mode selection control may include:
calling a sharing interface of the target intelligent vehicle based on the communication mode corresponding to the target sharing mode selection control; and
transmitting the subprogram sharing request to the target intelligent vehicle through the sharing interface.

In some embodiments, when the subprogram is shared in the Bluetooth communication mode, the Bluetooth communication mode may trigger detection of currently received data by the sharing interface of the target intelligent vehicle, so as to acquire the subprogram sharing request from the currently received data.

For example, in the sharing interface, a detection event may be designed. When an event pointed to the sharing interface is identified, a message received by Bluetooth is acquired and analyzed to acquire the subprogram sharing request, such that the subprogram association information is analyzed from the subprogram sharing request, for example, information such as Appid, page information, and page parameters params of the subprogram.

When the Bluetooth communication model calls the sharing interface, the transferred information may carry an identifier indicating that the current information is transmitted through Bluetooth or an identifier indicating that the information is transmitted through the sharing interface, and the like.

In some embodiments, when the subprogram is shared in the remote wireless communication mode, the sharing interface may be opened (opened) to call a page interface of the subprogram; then, the subprogram is pulled up through the network communication calling interface of the cloud.

As shown in FIG. 6, some embodiments provide another subprogram sharing method, executed by an intelligent vehicle, where a flow may be as follows:

601: Receive a subprogram sharing request, the subprogram sharing request carrying subprogram association information of a subprogram requested by a sharing initiating terminal to share.

In some embodiments, part of nouns has meanings the same as that in the foregoing subprogram sharing method, and for implementation details, reference may be made to the above descriptions.

The subprogram sharing request is request information that the sharing initiating terminal requests to share the subprogram to the intelligent vehicle. The sharing initiating terminal transmits the subprogram sharing request based on a communication mode corresponding to the target sharing mode selection control; the target sharing mode selection control is included in a subprogram sharing page of the subprogram displayed by the sharing initiating terminal, the subprogram sharing page includes at least one sharing mode selection control, and each sharing mode selection control corresponds to one communication mode; the sharing initiating terminal, in response to a triggering operation for a target sharing mode selection control in sharing mode selection controls, upon acquiring a target intelligent vehicle and subprogram association information of the subprogram, transmits the subprogram sharing request.

In some embodiments, in operation 601, the receiving a subprogram sharing request, the subprogram sharing request carrying subprogram association information of a subprogram requested by a sharing initiating terminal to share may include:
receiving a subprogram sharing request transmitted by a cloud corresponding to the intelligent vehicle, the subprogram sharing request carrying subprogram association information of the subprogram requested by the sharing initiating terminal to share and second identity authentication information of the cloud.

In an actual application, devices of the target intelligent vehicle, the cloud server, and the sharing initiating terminal and individuals issue corresponding digital certificates as evidence of identity authentication to verify digital signatures of counterparts. The authentication mode may not only identify the individual identity, but also flexibly control a range of application and the service life.

The second identity authentication information may be a digital certificate of the cloud.

Correspondingly, in operation 601, upon receiving the subprogram sharing request, the subprogram sharing method provided in some embodiments may further include:
performing identity verification on the cloud based on the second identity authentication information to obtain an identity verification result corresponding to the cloud; and
analyzing the subprogram sharing request is analyzed in response to the identity verification result being verification passed to obtain the subprogram association information.

The identity verification result may be information indicating that the second identity authentication information is inerrant, i.e., verification passed, and may also be information indicating that the second identity authentication information is wrong, i.e., verification failed. When the identity verification result is verification passed, the subprogram sharing request may be analyzed to obtain the subprogram association information; and when the identity verification result is verification failed, it is not allowed to analyze the subprogram sharing request.

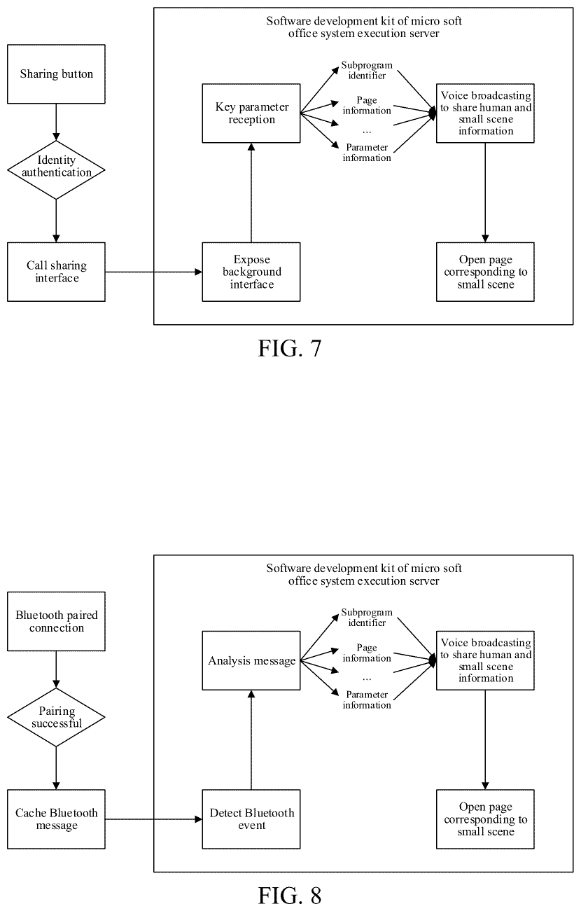

As shown in FIG. 7, on the premise of establishing a safe connection, if a mobile phone end has a subprogram sharing demand, i.e., opens a certain subprogram (referred to a mini program in FIG. 7), a user may click/tap a “more” button at a top right corner to pop more options, select a button of “share to vehicle”, and calls an interface of the cloud to transmit the subprogram through the network. Before the interface is called, identity authentication and right authentication may be performed first, and then the interface is called after authentication is passed, so that the communication safety is improved.

In some embodiments, an exposed interface may be designed in MossSDK (a software development kit of a Microsoft office system execution server) for receiving parameters of the subprogram, including information such as Appid, page information, and page parameters params of the subprogram.

In some embodiments, in operation 601, the receiving a subprogram sharing request may include:
receiving external transmission data and detecting the external transmission data through a detection code for a subprogram sharing event; and
analyzing the external transmission data when the subprogram sharing event exists in the external transmission data, to obtain the subprogram sharing request corresponding to the subprogram sharing event.

As shown in FIG. 8, a detection code for the subprogram (referred to a small scene in FIG. 8) sharing event may be designed in the MossSDK. When the subprogram sharing event pointed to the MossSDK is identified, a message received by Bluetooth is acquired and analyzed.

In some embodiments, the detection code of the subprogram detection event may be a Bluetooth event detection method designed in the MossSDK, for example, getSharedMiniProInfoByBlueTooth(). All information of the subprogram shared by the sharing initiating terminal may be acquired through the detection code of the subprogram sharing event, i.e., the subprogram association information, and after the subprogram association information is analyzed, all parameters capable of opening the subprogram are obtained.

602: Display a sharing acceptance confirming page based on the subprogram association information.

The sharing acceptance confirming page may be a page displayed on the intelligent vehicle in a process where the user of the intelligent vehicle confirms whether sharing of the subprogram is accepted.

In some embodiments, the sharing acceptance confirming page may include a sharing acceptance confirming control and/or a sharing refusing control and the like. The user may manually trigger the sharing acceptance confirming control to accept sharing of the subprogram.

In an actual application, the sharing acceptance confirming page may be displayed based on the parameters in the subprogram association information, and in operation 602, the displaying a sharing acceptance confirming page based on the subprogram association information may include:
acquiring the subprogram association information based on the subprogram sharing request;
analyzing the subprogram association information to obtain a subprogram page display parameter; and
displaying the sharing acceptance confirming page based on the subprogram page display parameter.

For example, the sharing acceptance confirming page may include “a BBB type CCC small scene shared by AAA, would you want to open or ignore?”, where AAA, BBB, and CCC may be subprogram page display parameters obtained by analyzing the subprogram association information.

603: Display, in response to a sharing acceptance operation of a user, a target subprogram page corresponding to the subprogram according to the subprogram association information.

The sharing acceptance operation may be a user manually confirmed operation, a voice confirmed operation, and the like, or the user may preset default accepted sharing if no operations is performed, etc.

In some embodiments, if the user accepts sharing in a voice instruction mode, in operation 603, the displaying, in response to a sharing acceptance operation of a user, a target subprogram page corresponding to the subprogram according to the subprogram association information may include:
receiving a voice input content of the user and analyzing the voice input content to obtain a sharing confirming result; and
displaying, in response to the sharing confirming result being sharing acceptance, the target subprogram page corresponding to the subprogram according to the subprogram association information.

Analyzing the voice input content may be realized by technologies such as voice recognition, which is not limited.

By triggering a voice broadcasting system of SDK, the intelligent vehicle may play, for example, “an XXX type xxx small scene shared by xxx, would you want to open or ignore?”. After a vehicle owner performs voice confirmation, an openMiniProgram () method of a frame is triggered to open the small scene, so as to realize viewing and sharing at the vehicle in the small scene.

In some embodiments, in order to guarantee the driving safety of the user and improve the driving experience of the user, whether the user accepts sharing of the subprogram may be promoted by way of voice broadcasting, and in operation 603, prior to the displaying, in response to a sharing acceptance operation of a user, a target subprogram page corresponding to the subprogram according to the subprogram association information, the subprogram sharing method in some embodiments may further include:
generating sharing broadcasting information based on the subprogram association information; and
performing voice broadcasting of the sharing broadcasting information.

In some embodiments, the sharing broadcasting information may be information of a character type and during voice broadcasting, audios corresponding to characters in the sharing broadcasting information may be spliced and played; or, the sharing broadcasting information may be information of an audio type, and during voice broadcasting, the sharing broadcasting information may be directly played.

For example, after the subprogram association information is obtained, the voice broadcasting system of the SDK may be triggered to play the sharing broadcasting information, and after the vehicle owner performs voice confirmation, the openMiniProgram () method of the frame may be triggered to open the target subprogram page, so as to realize viewing and sharing of the subprogram at the vehicle.

The content of the sharing broadcasting information may be “a life service small scene XX film shared by your friend A will open a detailed page of a YY film, would you want to open or ignore?” or, “vehicle owner service small scene preferential refueling shared by your friend A will open detailed information of a certain gas station, would you want to open or ignore?”, etc.

According to the method described in the foregoing embodiment, the following further provides detailed descriptions by using an example.

In some embodiments, descriptions will be made with reference to the system in FIG. 1.

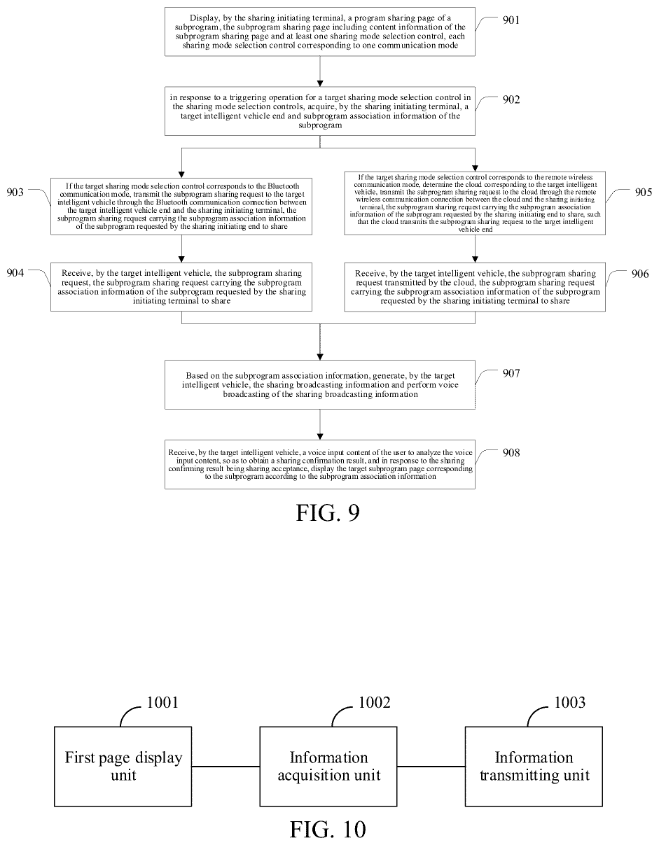

As shown in FIG. 9, a flow of the subprogram sharing method in some embodiments may be as follows:

901: A sharing initiating terminal displays a subprogram sharing page of a subprogram, the subprogram sharing page including content information of the subprogram and at least one sharing mode selection control, and each sharing model selection control corresponding to one communication mode.

If the sharing initiating terminal (for example, a mobile phone end) has a subprogram sharing demand, i.e., opens a certain subprogram, a user may click/tap a “more” button at the top right corner to pop more options, so as to select the sharing mode selection controls therein.

902: The sharing initiating terminal acquires a target intelligent vehicle and subprogram association information of the subprogram in response to a triggering operation for a target sharing mode selection control in sharing mode selection controls.

903: Transmit a subprogram sharing request to the target intelligent vehicle through a Bluetooth communication connection between the target intelligent vehicle and the sharing initiating terminal if the target sharing mode selection control corresponds to a Bluetooth communication mode, the subprogram sharing request carrying the subprogram association information of the subprogram requested by the sharing initiating terminal to share.

When the subprogram is shared within a short distance, first, the mobile phone end actively selects “share through Bluetooth” from a mini program page for Bluetooth pairing with a vehicle. After the connection is completed, the mobile phone end actively calls a sharing interface to transmit information such as Appid, page information, and page parameters params of the subprogram to the vehicle by Bluetooth for storage.

904: The target intelligent vehicle receives the subprogram sharing request, the subprogram sharing request carrying the subprogram association information of the subprogram requested by the sharing initiating terminal to share.

In the MossSDK, a detection event is designed, for example: getSharedMiniProInfoByBlueTooth(); when the event pointed to the MossSDK is identified, the message received by Bluetooth is acquired and the message is analyzed to acquire the subprogram association information, for example, information such as Appid, page information, and page parameter params of the subprogram. Based on the information, voice broadcasting is triggered to a driver, and after the driver confirms the voice broadcasting, the vehicle opens the corresponding subprogram.

The MossSDK may identify keywords with moss transferred by the sharing initiating terminal after the Bluetooth communication connection is established.

905: Determine a cloud corresponding to the target intelligent vehicle and transmit the subprogram sharing request to the cloud through a remote communication connection between the cloud and the sharing initiating terminal if the target sharing mode selection control corresponds to a remote wireless communication mode, the subprogram sharing request carrying the subprogram association information of the subprogram requested by the sharing initiating terminal to share, such that the cloud transmits the subprogram sharing request to the target intelligent vehicle.

When the subprogram is shared within a long distance, a Bluetooth technology can no longer be used, and the subprogram may be shared by way of the wireless network communication. First, the mobile phone end also actively selects “share to vehicle” from the mini program page. Before the interface is called, identity authentication and right authentication may be performed first, and then the interface is called after authentication is passed. An exposed interface may be designed in the MossSDK for receiving parameters of the subprogram, including information such as Appid, page information, and page parameters params of the subprogram.

906: The target intelligent vehicle receives a subprogram sharing request transmitted by the cloud, the subprogram sharing request carrying the subprogram association information of the subprogram requested by the sharing initiating terminal to share.

On the premise of establishing a safe connection, if the mobile phone end has the subprogram sharing demand, i.e., opens a certain subprogram, the user may click/tap the “more” button at the top right corner to pop more options, select the button of “share to vehicle”, and calls the interface of the cloud to transmit information such as Appid, page information, and page parameters params of the subprogram through the network. The information is analyzed to obtain all parameters capable of opening the subprogram.

907: The target intelligent vehicle generates sharing broadcasting information based on the subprogram association information and performs voice broadcasting of the sharing broadcasting information.

Taking the subprogram being a certain vehicle-mounted small scene as an example, an intelligent vehicle may trigger the voice broadcasting system of the SDK to play, for example, “an XXX type xxx small scene shared by xxx, would you want to open or ignore?”. After the vehicle owner performs voice confirmation, the openMiniProgram () method of the frame is triggered to open the small scene, so as to realize viewing and sharing at the vehicle in the small scene.

908: The target intelligent vehicle receives a voice input content of a user and analyzes the voice input content to obtain a sharing confirmation result, and displays, in response to the sharing confirming result being sharing acceptance, the target subprogram page corresponding to the subprogram according to the subprogram association information.

It can be known from the above that in some embodiments, the sharing initiating terminal may display the subprogram sharing page of the subprogram, the subprogram sharing page including content information of the subprogram and at least one sharing mode selection control, and each sharing mode selection control corresponding to one communication mode, acquire the target intelligent vehicle and the subprogram association information of the subprogram in response to the triggering operation for the target sharing mode selection control in the sharing mode selection controls, and transmit the subprogram sharing request to the target intelligent vehicle based on the communication mode corresponding to the target sharing mode selection control, the subprogram sharing request carrying the subprogram association information of the subprogram requested by the sharing imitating end to share, such that the target intelligent vehicle displays the target subprogram page corresponding to the subprogram based on the subprogram association information. In some embodiments, since the user of the sharing initiating terminal may select any communication mode through the sharing mode selection control in the subprogram sharing page to share the subprogram to the target intelligent vehicle to display, accordingly, subprogram sharing between the intelligent vehicle and the user terminal may be realized by using various communication modes, so that the user experience of the intelligent vehicle user is improved.

In order to better implement the above method, correspondingly, some embodiments further provide a subprogram sharing apparatus. The subprogram sharing apparatus may be integrated at the sharing initiating terminal. Nouns have meanings the same as that in the foregoing subprogram sharing method, and for implementation details, reference may be made to the description of the method according to some embodiments.

Referring to FIG. 10, some embodiments provide a subprogram sharing apparatus. The apparatus may be applied to a sharing initiating terminal and includes:
a first page display unit 1001, configured to display a subprogram sharing page of a subprogram, the subprogram sharing page including at least one sharing mode selection control, and each sharing mode selection control corresponding to one communication mode;
an information acquisition unit 1002, configured to acquire subprogram association information of the subprogram in response to a triggering operation for a target sharing mode selection control in sharing mode selection controls; and
an information transmitting unit 1003, configured to transmit a subprogram sharing request to the target intelligent vehicle based on a communication mode corresponding to the target sharing mode selection control, the subprogram sharing request carrying the subprogram association information of the subprogram requested by the sharing imitating end to share, such that the target intelligent vehicle displays a target subprogram page corresponding to the subprogram based on the subprogram association information.

To better implement the subprogram sharing method provided in some embodiments, in some embodiments, further provided is another subprogram sharing apparatus, and the subprogram sharing apparatus may be integrated into an intelligent vehicle. Nouns have meanings the same as that in the foregoing subprogram sharing method, and for implementation details, reference may be made to the descriptions of the method according to some embodiments.

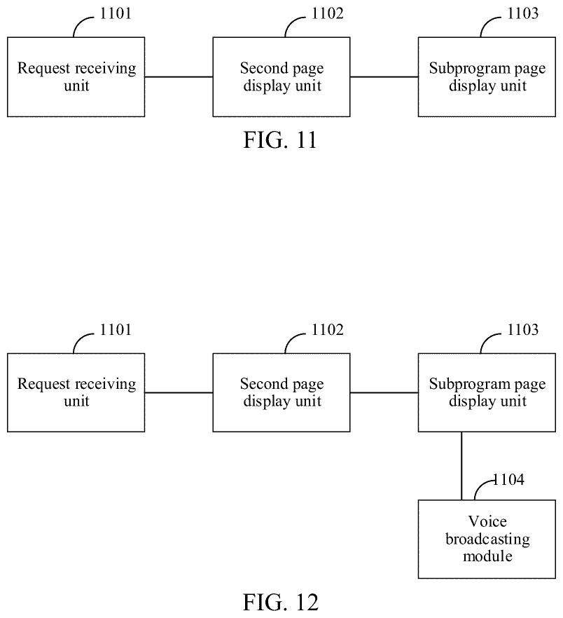

Referring to FIG. 11, some embodiments provide another subprogram sharing apparatus. The apparatus may be applied to an intelligent vehicle, and the intelligent vehicle is in communication connection to at least one sharing initiating terminal. The apparatus includes:
a request receiving unit 1101, configured to receive a subprogram sharing request transmitted by a terminal device based on a communication mode corresponding to a target sharing mode selection control, the subprogram sharing request including subprogram association information of a subprogram requested by a sharing initiating terminal to share, the target sharing mode selection control being included in a subprogram sharing page of the subprogram displayed by the terminal device, the subprogram sharing page including at least one sharing mode selection control, and each sharing mode selection control corresponding to one communication mode, and the terminal device, in response to a triggering operation for a target sharing mode selection control in sharing mode selection controls, upon acquiring a target intelligent vehicle and subprogram association information of the subprogram, transmitting the subprogram sharing request;
a second page display unit 1102, configured to display a sharing acceptance confirming page based on the subprogram association information; and
a subprogram page display unit 1103, configured to display, in response to a sharing acceptance operation of a user, a target subprogram page corresponding to the subprogram according to the subprogram association information.

In some embodiments, as shown in FIG. 12, the subprogram sharing apparatus provided in some embodiments may further include a voice broadcasting unit 1104, configured to generate sharing broadcasting information based on the subprogram association information; and
perform voice broadcasting of the sharing broadcasting information.

According to some embodiments, each unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. In actual applications, these functions may also be realized cooperatively by the other units, and may be realized cooperatively by multiple units.

A person skilled in the art would understand that these “units” could be implemented by hardware logic, a processor or processors executing computer software code, or a combination of both. The “units” may also be implemented in software stored in a memory of a computer or a non-transitory computer-readable medium, where the instructions of each unit are executable by a processor to thereby cause the processor to perform the respective operations of the corresponding unit.

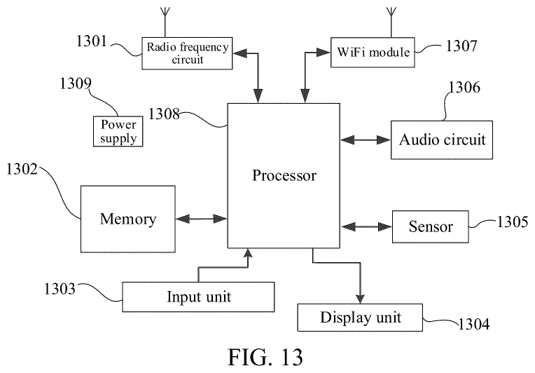

In addition, some embodiments further provides an electronic device. The electronic device may be a terminal or a server, and the like. FIG. 13 shows a schematic structural diagram of the electronic device involved in some embodiments.

The electronic device may include a radio frequency (RF) circuit 1301, a memory 1302 including one or more computer-readable storage media, an input unit 1303, a display unit 1304, a sensor 1305, an audio circuit 1306, a wireless fidelity (Wi-Fi) module 1307, a processor 1308 including one or more processing cores, and a power supply 1309 and the like. The electronic device structure shown in FIG. 13 does not constitute a limitation to the electronic device. The server may include more or fewer parts than those shown in the figure, may combine some parts, or may have different part arrangements. In the electronic device:
the RF circuit 1301 may be configured for receiving and transmitting a message, or receiving and transmitting a signal during a call. After receiving downlink information from a base station, the RF circuit transmits the downlink information to the one or more processors 1308 for processing. In addition, the RF circuit transmits related uplink data to the base station. The RF circuit 1301 includes, but is not limited to, an antenna, at least one amplifier, a tuner, one or more oscillators, a subscriber identity module (SIM) card, a transceiver, a coupler, a low noise amplifier (LNA), a duplexer, and the like. In addition, the RF circuit 1301 may also communicate with a network and another device in a wireless manner. The wireless communication may use any communication standard or protocol, including, but not limited to, global system for mobile communication (GSM), general packet radio service (GPRS), code division multiple access (CDMA), wideband code division multiple access (WCDMA), long term evolution (LTE), email, short messaging service (SMS), and the like.

The memory 1302 may be configured to store a software program and a module. The processor 1308 runs the software program and the module that are stored in the memory 1302, to perform various functional applications and data processing. The memory 1302 may mainly include a program storage area and a data storage area. The program storage area may store an operating system, an application for at least one function (for example, a sound playback function and an image playback function), and the like. The data storage area may store data (for example, audio data and a phone book) created based on use of the electronic device, and the like. In addition, the memory 1302 may include a high speed random access memory, and may further include a non-volatile memory, such as at least one magnetic disk storage device, a flash memory, or another volatile solid-state storage device. Correspondingly, the memory 1302 may further include a memory controller, to provide access of the processor 1308 and the input unit 1303 to the memory 1302.

The input unit 1303 may be configured to receive inputted figure or character information and generate keyboard, mouse, operating rod, optical or trackball signal inputs related to user settings and function control. In some embodiments, the input unit 1303 may include a touch sensitive surface and another input device. The touch sensitive surface, which may also be referred to as a touch display screen or a touch panel, may collect a touch operation of a user on or near the touch panel (such as an operation of the user on or near the touch panel performed by using an object or accessory such as a finger or a stylus), and drive a corresponding connection apparatus according to a preset program. In some embodiments, the touch sensitive surface may include two parts: a touch detection apparatus and a touch controller. The touch detection apparatus detects a touch position of the user, and detects a signal generated by the touch operation and transfers the signal to the touch controller. The touch controller receives touch information from the touch detection apparatus, and converts the touch information into touch point coordinates, and then transmits the touch point coordinates to the processor 1308. Moreover, the touch controller can receive a command transmitted from the processor 1308 and execute the command. In addition, the touch sensitive surface may be implemented by various types, such as a resistive type, a capacitance type, an infrared type, and a surface sound wave type. In addition to the touch sensitive surface, the input unit 1303 may further include the another input device. Another input device may include, but is not limited to, one or more of a physical keyboard, a functional key (such as a volume control key and a switch key), a track ball, a mouse, and a joystick, and the like.

The display unit 1304 may be configured to display information inputted by the user or information provided to the user and various graphical user interfaces of the electronic device. The graphical user interfaces can be formed by graphics, texts, icons, videos and any combination thereof. The display unit 1304 may include a display panel. In some embodiments, the display panel may be configured in the form of a liquid crystal display (LCD), an organic light-emitting diode (OLED), and the like. Further, the touch sensitive surface may cover the display panel. After detecting a touch operation on or near the touch sensitive surface, the touch sensitive surface transfers the touch operation to the processor 1308, to determine a type of a touch event. Then, the processor 1308 provides a corresponding visual output on the display panel according to the type of the touch event. Although in FIG. 13, the touch sensitive surface and the display panel are used as two separate parts to implement input and output functions, in some embodiments, the touch sensitive surface and the display panel may be integrated to implement the input and output functions.

The electronic device may further include at least one sensor 1305 such as an optical sensor, a motion sensor, and other sensors. The optical sensor may include an ambient light sensor and a proximity sensor, where the ambient light sensor may adjust luminance of the display panel according to the luminance of the ambient light, and the proximity sensor may switch off the display panel and/or backlight when the electronic device is moved to the ear. As one type of motion sensor, a gravitational acceleration sensor may detect magnitudes of accelerations in various directions (on three axes), may detect magnitude and a direction of the gravity when static, and may be used in an application to recognize the attitude of the mobile phone (for example, switching between landscape orientation and portrait orientation, a related game, and magnetometer attitude calibration), a function related to recognition of vibration (such as a pedometer and a knock), and the like. Other sensors, such as a gyroscope, a barometer, a hygrometer, a thermometer, and an infrared sensor, may be configured in the electronic device.

The audio circuit 1306, a speaker, and a microphone may provide audio interfaces between the user and the electronic device. The audio circuit 1306 may convert received audio data into an electric signal and transmit the electric signal to the speaker. The speaker converts the electric signal into a sound signal and outputs the sound signal. In another aspect, the microphone converts a collected sound signal into an electric signal. The audio circuit 1306 receives the electric signal, converts the electric signal into audio data, and then outputs the audio data to the processor 1308 for processing. Then, the processor transmits the audio data to, for example, another electronic device by the RF circuit 1301, or outputs the audio data to the memory 1302 for further processing. The audio circuit 1306 may further include an earplug jack to provide a communication between a peripheral headset and the electronic device.

Wi-Fi is a short-distance wireless transmission technology. The electronic device may help, by using the Wi-Fi module 1307, a user to receive and transmit an email, browse a web page, access stream media, and the like, to allow wireless broadband Internet access of the user.

The processor 1308 is a control center of the electronic device and configured to connect all parts of the entire mobile phone by using various interfaces and lines, and executes various functions of the electronic device and processes data by running or executing the software program and/or module stored in the memory 1302 and calling data stored in the memory 1302. In some embodiments, the processor 1308 may include one or more processing cores. In some embodiments, an application processor and a modem processor may be integrated into the processor 1308. The application processor mainly processes an operating system, a user interface, an application, and the like, and the modem processor mainly processes wireless communication. The foregoing modem may either not be integrated into the processor 1308.

The electronic device further includes the power supply 1309 (such as a battery) for supplying power to the components. In some embodiments, the power supply may be logically connected to the processor 1308 via a power supply management system, thereby implementing functions such as charging, discharging, and power consumption management based on the power supply management system. The power supply 1309 may further include one or more of a direct current or alternating current power supply, a re-charging system, a power failure detection circuit, a power supply converter or inverter, a power supply state indicator, and any other components.

The electronic device may further include a camera, a Bluetooth module, and the like. In some embodiments, the processor 1308 in the electronic device may load, according to the following instructions, executable files corresponding to processes of one or more application programs into the memory 1302. The processor 1308 runs the application programs stored in the memory 1302, to implement various functions, for example:
the application program may be applied to the sharing initiating terminal and the sharing initiating terminal is in communication connection to at least one intelligent vehicle.

The processor 1308 runs the application program stored in the memory 1302 to display the subprogram sharing page of the subprogram, the subprogram sharing page including content information of the subprogram and at least one sharing mode selection control, and each sharing mode selection control corresponding to one communication mode;
acquires a target intelligent vehicle and subprogram association information of the subprogram in response to a triggering operation for a target sharing mode selection control in sharing mode selection controls; and
transmits a subprogram sharing request to the target intelligent vehicle based on a communication mode corresponding to the target sharing mode selection control, the subprogram sharing request carrying the subprogram association information of the subprogram requested by the sharing imitating end to share, such that the target intelligent vehicle displays a target subprogram page corresponding to the subprogram based on the subprogram association information.

Or, the application program may be applied to the intelligent vehicle, and the intelligent vehicle is in communication connection to at least one sharing initiating terminal.

The processor 1308 runs the application program stored in the memory 1302 to receive the subprogram sharing request, the subprogram sharing request carrying subprogram association information of a subprogram requested by a sharing initiating terminal to share;
displays a sharing acceptance confirming page based on the subprogram association information; and
displays, in response to a sharing acceptance operation of a user, a target subprogram page corresponding to the subprogram according to the subprogram association information.

All or some operations of the methods in some embodiments may be implemented by using instructions, or implemented through instructions controlling relevant hardware, and the instructions may be stored in a computer-readable memory and loaded and executed by a processor.

Accordingly, some embodiments provide a computer-readable storage medium, having a plurality of instructions stored therein. The instructions can be loaded by the processor, to execute the operations in any subprogram sharing method according to some embodiments. For example, the instructions may execute the following operations:
the instructions stored in the computer-readable storage medium may be applied to the sharing initiating terminal, and the sharing initiating terminal is in communication connection to at least one intelligent vehicle.

The instructions can be loaded by the processor to display a subprogram sharing page of the subprogram, the subprogram sharing page including content information of the subprogram and at least one sharing mode selection control, and each sharing mode selection control corresponding to one communication mode;
acquire a target intelligent vehicle and subprogram association information of the subprogram in response to a triggering operation for a target sharing mode selection control in sharing mode selection controls; and
transmit a subprogram sharing request to the target intelligent vehicle based on a communication mode corresponding to the target sharing mode selection control, the subprogram sharing request carrying the subprogram association information of the subprogram requested by the sharing imitating end to share, such that the target intelligent vehicle displays a target subprogram page corresponding to the subprogram based on the subprogram association information.

Or, the instructions stored in the computer-readable storage medium may be applied to the intelligent vehicle, and the intelligent vehicle is in communication connection to at least one sharing initiating terminal.

The instructions can be loaded by the processor to receive the subprogram sharing request, the subprogram sharing request carrying subprogram association information of the subprogram requested by the sharing initiating terminal to share;
display a sharing acceptance confirming page based on the subprogram association information; and
display, in response to a sharing acceptance operation of a user, a target subprogram page corresponding to the subprogram according to the subprogram association information.

For implementation details of the above operations, refer to the foregoing descriptions.

The computer-readable storage medium may include: a read-only memory (ROM), a random access memory (RAM), a magnetic disk, an optical disc, or the like.

Since the instructions stored in the computer-readable storage medium may execute the operations of any subprogram sharing method according to some embodiments, the instructions may implement advantageous effects that may be implemented by any subprogram sharing method according to some embodiments.

According to some embodiments, further provided is a computer program product or a computer program, the computer program product or the computer program including computer instructions, and the computer instructions being stored in the computer-readable storage medium. A processor of the electronic device reads the computer instructions from the computer-readable storage medium, and the processor executes the computer instructions to enable the electronic device to execute the methods provided in some embodiments.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A subprogram sharing method, executed by a terminal device, the method comprising:
displaying a subprogram sharing page of a subprogram, the subprogram sharing page comprising at least one sharing mode selection control, wherein the at least one sharing mode selection control corresponds to at least one communication mode;
acquiring target intelligent vehicle information of a target vehicle and subprogram association information of the subprogram based on a first triggering operation for a first control among a plurality of sharing mode selection controls; and
transmitting a subprogram sharing request to the target vehicle based on a communication mode corresponding to the first control, the subprogram sharing request carrying the subprogram association information, to cause the target vehicle to display, via a first display of the target vehicle, a target subprogram page corresponding to the subprogram based on the subprogram association information.

2. The subprogram sharing method according to claim 1, wherein the first control corresponds to a Bluetooth communication mode, and
wherein the transmitting the subprogram sharing request to the target vehicle comprises:
generating a Bluetooth sharing event based on the Bluetooth communication mode and the subprogram association information; and
transmitting the Bluetooth sharing event to the target vehicle through a Bluetooth communication connection between the target vehicle and the terminal device.

3. The subprogram sharing method according to claim 1, wherein the first control corresponds to a remote wireless communication mode, and
wherein the transmitting the subprogram sharing request to the target vehicle comprises:
generating a remote sharing event based on the remote wireless communication mode and the subprogram association information;
determining a cloud server for to the target vehicle; and
transmitting the remote sharing event to the cloud server through a remote communication connection between the cloud server and the terminal device, to cause the cloud server to transmit the remote sharing event to the target vehicle end.

4. The subprogram sharing method according to claim 3, wherein the transmitting the remote sharing event to the cloud server comprises:
transmitting first identity authentication information of the terminal device to the cloud server through the remote communication connection, to cause the cloud server to perform identity verification on the terminal device based on the first identity authentication information;
receiving an identity verification result of the terminal device from the cloud server; and
transmitting the remote sharing event to the cloud server through the remote communication connection based on the identity verification result indicating the identity verification succeeded.

5. The subprogram sharing method according to claim 1, wherein the transmitting the subprogram sharing request comprises:
calling a sharing interface of the target vehicle based on the communication mode corresponding to the first control; and
transmitting the subprogram sharing request to the target vehicle through the sharing interface.

6. The subprogram sharing method according to claim 1, wherein the acquiring the target intelligent vehicle information comprises:
displaying, based on the first triggering operation, via a second display of the terminal device, a sharing vehicle selection page comprising a vehicle selection control corresponding to at least one intelligent vehicle end; and
determining the target intelligent vehicle information based on a second triggering operation for a second control among one or more vehicle selection controls, wherein the target intelligent vehicle information corresponds to the first control.

7. The subprogram sharing method according to claim 1, wherein the subprogram is configured to run on a host program, and
wherein the host program comprises: an operating system, a server program, or an application program.

8. The subprogram sharing method according to claim 7, wherein the host program is the application program, and
wherein the application program comprises at least one of: an instant messaging client program or a music play program.

9. The subprogram sharing method according to claim 1, wherein the first control corresponds to a wired communication mode.

10. The subprogram sharing method according to claim 4, wherein the first identity authentication information comprises a digital certificate of the terminal device.

11. A terminal device comprising:
at least one memory configured to store computer program code; and
at least one processor configured to read the program code and operate as instructed by the program code, the program code comprising:
first page display code configured to cause at least one of the at least one processor to display a subprogram sharing page of a subprogram, the subprogram sharing page comprising at least one sharing mode selection control, and wherein the at least one sharing mode selection control corresponds to at least one communication mode;
information acquisition code configured to cause at least one of the at least one processor to acquire target intelligent vehicle information of a target vehicle and subprogram association information of the subprogram based on a first triggering operation for a first control among a plurality of sharing mode selection controls; and
information transmitting code configured to cause at least one of the at least one processor to transmit a subprogram sharing request to the target vehicle end based on a communication mode corresponding to the first control, the subprogram sharing request carrying the subprogram association information, to cause the target vehicle to display, via a first display of the target vehicle, a target subprogram page corresponding to the subprogram based on the subprogram association information.

12. The terminal device according to claim 11, wherein the first control corresponds to a Bluetooth communication mode, and
wherein the information transmitting code is configured to cause at least one of the at least one processor to:
generate a Bluetooth sharing event based on the Bluetooth communication mode and the subprogram association information; and
transmit the Bluetooth sharing event to the target vehicle through a Bluetooth communication connection between the target vehicle and the terminal device.

13. The terminal device according to claim 11, wherein the first control corresponds to a remote wireless communication mode, and
wherein the information transmitting code is configured to cause at least one of the at least one processor to:
generate a remote sharing event based on the remote wireless communication mode and the subprogram association information;
determine a cloud server for to the target vehicle; and
transmit the remote sharing event to the cloud server through a remote communication connection between the cloud server and the terminal device, to cause the cloud server to transmit the remote sharing event to the target vehicle end.

14. The terminal device according to claim 13, wherein the information transmitting code is configured to cause at least one of the at least one processor to:
transmit first identity authentication information of the terminal device to the cloud server through the remote communication connection, to cause the cloud server to perform identity verification on the terminal device based on the first identity authentication information;
receive an identity verification result of the terminal device from the cloud server; and
transmit the remote sharing event to the cloud server through the remote communication connection based on the identity verification result indicating the identity verification succeeded.

15. The terminal device according to claim 11, wherein the information transmitting code is configured to cause at least one of the at least one processor to:
call a sharing interface of the target vehicle based on the communication mode corresponding to the first control; and
transmit the subprogram sharing request to the target vehicle through the sharing interface.

16. The terminal device according to claim 11, wherein the information acquisition code is configured to cause at least one of the at least one processor to:
display, based on the first triggering operation, via a second display of the terminal device, a sharing vehicle selection page comprising a vehicle selection control corresponding to at least one intelligent vehicle end; and
determine the target intelligent vehicle information based on a second triggering operation for a second control among one or more vehicle selection controls, wherein the target intelligent vehicle information corresponds to the first control.

17. The terminal device according to claim 11, wherein the subprogram is configured to run on a host program, and
wherein the host program comprises: an operating system, a server program, or an application program.

18. The terminal device according to claim 17, wherein the host program is the application program, and
wherein the application program comprises at least one of: an instant messaging client program or a music play program.

19. The terminal device according to claim 11, wherein the first control corresponds to a wired communication mode.

20. A non-transitory computer-readable storage medium, storing computer code which, when executed by at least one processor, causes the at least one processor to at least:
display a subprogram sharing page of a subprogram, the subprogram sharing page comprising at least one sharing mode selection control, and wherein the at least one sharing mode selection control corresponds to at least one communication mode;
acquire target intelligent vehicle information of a target vehicle and subprogram association information of the subprogram based on a first triggering operation for a first control among a plurality of sharing mode selection controls; and
transmit a subprogram sharing request to the target vehicle end based on a communication mode corresponding to the first control, the subprogram sharing request carrying the subprogram association information, to cause the target vehicle to display, via a first display of the target vehicle, a target subprogram page corresponding to the subprogram based on the subprogram association information.
